(19) United States
(12) Patent Application Publication
(10) Pub. No.: US 2018/0088243 A1
(43) Pub. Date: Mar. 29, 2018

(54) RECEIVER AND METHOD FOR OPERATION WITH DIFFERENT SATELLITE NAVIGATION SYSTEMS

(71) Applicant: Marvell World Trade Ltd., St. Michael (BB)

(72) Inventors: Yongsong Wang, Shanghai (CN); Zhike Jia, Fremont, CA (US); Juhong Xing, Shanghai (CN); Kun Xu, Shanghai (CN)

(21) Appl. No.: 15/411,032

(22) Filed: Jan. 20, 2017

Related U.S. Application Data
(60) Provisional application No. 62/400,295, filed on Sep. 27, 2016.
(60) Provisional application No. 62/431,245, filed on Dec. 7, 2016.

(51) Int. Cl. G01S 19/33; G01S 19/48; G01S 19/23

(52) U.S. Cl. CPC G01S 19/33; G01S 19/235; G01S 19/48

(57) ABSTRACT

A method of determining a navigational position from satellite navigation signals includes receiving at a satellite navigation receiver a plurality of satellite navigation signals, where each respective satellite navigation signal was transmitted by a respective satellite each of which belongs to one of a plurality of satellite navigation system. Each respective satellite navigation signal transmitted by the respective satellite includes time data based on a time base of a respective satellite navigation system to which the respective satellite belongs. The time data in at least one respective satellite signal is converted from the time base of the respective satellite navigation system to which the respective satellite belongs to make each satellite navigation signal usable with each other satellite navigation signal to derive the position. In one implementation, the conversion involves a known relationship between time bases, as well as a measured hardware correction, and results in a common time base.

### CROSS REFERENCE TO RELATED APPLICATION

This claims the benefit of copending, commonly-assigned U.S. Provisional Patent Applications Nos. 62/400,295 and 62/431,245, filed Sep. 27, 2016 and Dec. 7, 2016, respectively, each of which is hereby incorporated by reference herein in its respective entirety.

### FIELD OF USE

Implementations of the subject matter of this disclosure generally pertain to a method for operating a satellite navigation receiver to determine a position based on satellites from a mixture of different satellite systems or constellations, and a satellite navigation receiver so equipped.

### BACKGROUND

The background description provided herein is for the purpose of generally presenting the context of the disclosure. Work of the inventors hereof, to the extent the work is described in this background section, as well as aspects of the description that may not otherwise qualify as prior art at the time of filing, are neither expressly nor impliedly admitted to be prior art against the present disclosure.

A number of different satellite navigation systems exist, including the Global Positioning System (GPS) operated by the United States of America, the Global Navigation Satellite System (GLONASS) operated by the Russian Federation, the Beidou (formerly known as COMPASS) system operated by the People's Republic of China, and the Galileo system operated by the European Union. Other systems, which are primarily regional, rather than global, in coverage, are operated by other nations, such as India. Even though some of these systems are not global in coverage, the systems are known collectively as global navigation satellite systems (GNSSs).

The different GNSS systems operate on similar principles. A constellation of satellites is placed in orbit. Each satellite continually broadcasts information regarding its position and the current time. If a receiver can access signals from enough satellites at once, the position of the receiver, as well as the current time at the receiver position, can be determined with known accuracy based on the solution of simultaneous equations representing the distance to each satellite as function of time and the speed of light. Reception of signals from four satellites provides four equations in four unknowns (three spatial coordinates and time), allowing all four unknowns to be determined. Three satellites may be enough to provide accurate position data if determination of time is not important.

Within any one GNSS system, the clocks on all satellites are synchronized. However, the time bases used by the different GNSS systems are different. Therefore, a given receiver can only be used with a particular GNSS system for which it has been designed or programmed.

### SUMMARY

A method of determining a navigational position from satellite navigation signals includes receiving at a satellite navigation receiver a plurality of satellite navigation signals, each respective satellite navigation signal having been transmitted by a respective satellite in a plurality of satellites. At least a first satellite in the plurality of satellites belongs to a first satellite navigation system and at least a second satellite in the plurality of satellites belongs to a second satellite navigation system. Each respective satellite navigation signal transmitted by the respective satellite includes time data based on a time base of a respective satellite navigation system to which the respective satellite belongs. The method also includes converting the time data in at least one respective satellite signal from the time base of the respective satellite navigation system to which the respective satellite belongs to make each satellite navigation signal of the plurality of satellite navigation signals usable with each other satellite navigation signal of the plurality of satellite navigation signals, and deriving the navigational position from the plurality of satellite navigation signals following the converting of the time data in the at least one respective satellite signal.

In one implementation of the method, the converting includes applying a known relationship between at least a time base of the first satellite navigation system and a time base of the second satellite navigation system, and applying a measured hardware correction at the satellite navigation receiver for at least one of the time base of the first satellite navigation system and the time base of the second satellite navigation system.

In such an implementation, the converting results in conversion of the time base of the first satellite navigation system and the time base of the second satellite navigation system to a common time base. In one variant, the common time base is one of the time base of the first satellite navigation system and the time base of the second satellite navigation system. In another variant, the common time base is a time base other than the time base of the first satellite navigation system and the time base of the second satellite navigation system. In one such variant, the common time base is Coordinated Universal Time.

In such an implementation, the deriving the navigational position from the plurality of satellite navigation signals includes deriving the navigational position from the plurality of satellite navigation signals that have been converted to the common time base.

In a variant of such an implementation, at least a third satellite in the plurality of satellites belongs to a third satellite navigation system, there being a time base of the third satellite navigation system, the applying the known relationship comprises applying known relationships among the time base of the first satellite navigation system, the time base of the second satellite navigation system and the time base of third satellite navigation system, and the applying the measured hardware correction at the satellite navigation receiver comprises applying a respective measured hardware correction for each of the time base of each of the first satellite navigation system, the time base of the second satellite navigation system and the time base of the third satellite navigation system.

In such a variant, the converting results in conversion of the time base of the first satellite navigation system, the time base of the second satellite navigation system, and time base of the third satellite navigation system, to a common time base. In one such variant, the common time base is one of the time base of the first satellite navigation system, the time base of the second satellite navigation system and the time base of the third satellite navigation system. In another such variant, the common time base is a time base other than the time base of the first satellite navigation system, the time base of the second satellite navigation system and the time base of the third satellite navigation system. In one version of such a variant, the common time base is Coordinated Universal Time.

In a variant of such an implementation, the deriving the navigational position from the plurality of satellite navigation signals includes deriving the navigational position from the plurality of satellite navigation signals that have been converted to the common time base.

A method of configuring a satellite navigation system receiver to operate with satellites from more than one satellite navigation system includes measuring a respective clock delay of the satellite navigation system receiver for each one of the more than one satellite system, and storing the respective measured clock delays in a respective memory accessible to a positioning engine in the satellite navigation system receiver.

A satellite navigation system receiver includes a receiver configured to receive a plurality of satellite navigation signals, each respective satellite navigation signal having been transmitted by a respective satellite in a plurality of satellites, wherein at least a first satellite in the plurality of satellites belongs to a first satellite navigation system and at least a second satellite in the plurality of satellites belongs to a second satellite navigation system, and wherein each respective satellite navigation signal transmitted by the respective satellite includes time data based on a time base of a respective satellite navigation system to which the respective satellite belongs. The satellite navigation system receiver also includes a positioning engine including timing compensation circuitry configured to convert the time data in at least one respective satellite signal from the time base of the respective satellite navigation system to which the respective satellite belongs to make each satellite navigation signal of the plurality of satellite navigation signals usable with each other satellite navigation signal of the plurality of satellite navigation signals, and a navigation filter in the positioning engine, the navigation filter being configured to derive the navigational position from the plurality of satellite navigation signals following converting by the timing compensation circuitry of the time data in the at least one respective satellite signal.

In one implementation, the timing compensation circuitry is configured to apply a known relationship between at least a time base of the first satellite navigation system and a time base of the second satellite navigation system, the timing compensation circuitry is configured to apply a measured hardware correction at the satellite navigation receiver for at least one of the time base of the first satellite navigation system and the time base of the second satellite navigation system.

In one such implementation, the timing compensation circuitry converts the time base of the first satellite navigation system and the time base of the second satellite navigation system to a common time base. On one variant, the common time base is one of the time base of the first satellite navigation system and the time base of the second satellite navigation system. In another variant, the common time base is a time base other than the time base of the first satellite navigation system and the time base of the second satellite navigation system. In a version of such a variant, the common time base is Coordinated Universal Time.

### BRIEF DESCRIPTION OF THE DRAWINGS

Features of the subject matter of the disclosure, its nature and various advantages, will be apparent upon consideration of the following detailed description, taken in conjunction with the accompanying drawings, in which like reference characters refer to like parts throughout, and in which:

FIG. 1 shows conversion between two time bases according to a first implementation of the subject matter of this disclosure;

FIG. 2 shows conversion between two time bases according to a second implementation of the subject matter of this disclosure;

FIG. 3 shows conversion between two time bases according to a first implementation of the subject matter of this disclosure;

FIG. 4 shows conversion between two time bases according to a second implementation of the subject matter of this disclosure;

FIG. 5 shows acquisition of frame synchronization of a single satellite;

FIG. 6 shows determination of times of transmission of signals from multiple satellites when range uncertainty is small;

FIG. 7 shows a schematic representation of a navigation satellite system receiver according to implementations of the subject matter of this disclosure;

FIG. 8 is a flow diagram of a method for configuring a satellite navigation system receiver in accordance with an implementation of the subject matter of this disclosure; and

FIG. 9 is a flow diagram of a method for determining position using a satellite navigation system receiver in accordance with an implementation of the subject matter of this disclosure.

### DETAILED DESCRIPTION

According to implementations of the subject matter of this disclosure, a global navigation satellite system receiver can use signals from satellites belonging to different global navigation satellite systems. Therefore, the receiver will be able to more quickly acquire signals from a sufficient number of satellites to determine position, time, or both.

As noted above, in a global navigation satellite system, a constellation of satellites is placed in orbit. Each satellite continually broadcasts information regarding its position and the current time. If a receiver can access signals from enough satellites at once, the position of the receiver, as well as the current time at the receiver position, can be determined with known accuracy based on simultaneous equations representing the distance to each satellite as function of time and the speed of light. Reception of signals from four satellites provides four equations in four unknowns (three spatial coordinates and time), allowing all four unknowns to be determined. Three satellites may be enough to provide accurate position data if determination of time is not important.

According to a simplified explanation, if time is known accurately, then if a signal is acquired from only one satellite, the time information sent by that satellite can establish a distance to that satellite, and the known position of the satellite can establish that the receiver is on the surface of a sphere, centered on the satellite, and having a radius equal to the distance to the satellite. If a signal is acquired from a second satellite, it can be established that the receiver also is on the surface of a sphere centered on the second satellite. Therefore, the receiver is located somewhere on a circle that is the intersection of those two spheres. If a third satellite is added, the position can be narrowed down to the two points where three spheres intersect, and one of the points can be easily discarded because it almost certainly would lie either in outer space or within the interior of the planet.

As a practical matter, the equations are solved simultaneously, rather than deriving the three spheres individually and then finding their intersections. Addition of a fourth satellite yields a fourth equation that allows the direct determination of the single point of interest (rather than two candidate points), or if time is not known accurately to start out, the determination of time as a fourth unknown variable. Addition of a fifth satellite allows the determination of the single point of interest and the time, even if time is not known accurately to start out. Beyond that, at six or more satellites, the system is overdetermined.

Actual implementations are more complex than the foregoing simplified description. Any clock present in a GNSS receiver is likely to be less accurate than the clocks carried by the satellites (normally, atomic clocks are used on the satellites, while quartz clocks are used in the receivers). Therefore a solution is usually derived by starting out with an approximation of the distance to a satellite, known as a pseudorange, based on the time-of-transit (the time interval required for the signal from the satellite to reach the receiver) represented by the difference between the local receiver clock at the moment of signal reception and the received time signal from the satellite. This distance is referred to as a pseudorange because even a small time error in the local clock (“receiver clock bias”) results in a large distance error after multiplication by the speed of light, so the result may not be the true range. However, as long as the receiver clock bias is the same for all measurements, it cancels out of the simultaneous equations. And after one solution involving at least four satellites is obtained, the receiver clock bias is known, which can be used to correct the local time and improve subsequent solutions (as long as the clock bias does not drift).

In addition, corrections for the Doppler Effect, and for effects caused by passage of the satellite signal through the atmosphere, may be applied. Information may be included in the satellite signal to assist with atmospheric corrections.

Taking GPS as an example (the other GNSS systems are similar), a complete satellite navigation signal is 1500 bits long, divided into five 300-bit frames. Each frame is 6 seconds long, and therefore each bit is 20 ms long. Each frame starts with a 30-bit “telemetry word (TLM)” followed by a 30-bit “handover word (HOW).” The remainder of each frame (240 bits) includes data relating to time, various navigation parameters (“ephemeris” and “almanac” data), atmospheric modelling data (see above), or satellite health data.

A straightforward way of proceeding is for the receiver to lock onto each of four satellites individually, through processes referred to as “bit synchronization” and “frame synchronization.” The time signal from each satellite can then be decoded to yield a time-of-transmission by the satellite, and then a pseudorange (p) to that satellite, based on the time-of-receipt according to the receiver local clock, can be determined. The receiver position (x, y, z) and clock bias (b) can then be calculated from the four pseudoranges according to the following equation:

$$[ \begin{matrix}{h}_{11} & {h}_{12} & {h}_{13} & 1 \\ {h}_{21} & {h}_{22} & {h}_{23} & 1 \\ {h}_{31} & {h}_{32} & {h}_{33} & 1 \\ {h}_{41} & {h}_{42} & {h}_{43} & 1\end{matrix} ] [ \begin{matrix}x \\ y \\ z \\ b\end{matrix} ] = [ \begin{matrix}{ρ}_{1} \\ {ρ}_{2} \\ {ρ}_{3} \\ {ρ}_{4}\end{matrix} ]$$

where each hᵢⱼ is a directional cosine between the receiver and the ith satellite along one of three orthogonal spatial axes (j=1, 2, 3).

However, proceeding in such a straightforward manner requires searching several hundred bits of each satellite signal to find the synchronization bits of each signal. This process can be improved once frame synchronization for a first satellite is accomplished. Because all navigation messages are sent out at the same time by all satellites in a particular GNSS system, the difference in distance to the different satellites can result in only 1-2 bits of alignment difference between satellite signals. Therefore, once frame synchronization for a first satellite is accomplished, the search range for the synchronization bits in the signals from other satellites can be reduced to 2 bits, or about 40 ms.

It also is possible to eliminate the need for accurate local time at the receiver. Taking three satellites i, j, k, the pseudorange to each is:

ρᵢ=c×(tor−totᵢ)

ρⱼ=c×(tor−totⱼ)

ρₖ=c×(tor−totₖ)

where c is the speed of light, tor is the time of receipt of the satellite signal at the GNSS receiver, and totₙ is the time of transmission by the nth satellite. tor−totₙ is sometimes referred to as the “time of transit” for the signal from the nth satellite. The following relationships can be derived:

ρᵢ−ρⱼ=c×((tor−totᵢ)−(tor−totⱼ))=c×(totⱼ−totᵢ)

ρⱼ−ρₖ=c×((tor−totⱼ)−(tor−totₖ))=c×(totₖ−totⱼ)

ρₖ−ρᵢ=c×((tor−totₖ)−(tor−totᵢ))=c×(totᵢ−totₖ)

Thus, accurate tor is not important if accurate totₙ is available. Once one totₙ is known, the uncertainty of any other totₙ depends on the range accuracy. But the maximum range between a receiver on or near the surface of the earth and one of the satellites in low-earth orbit is within 20 ms×c. That means that once one totₙ is known, the uncertainty of any other totₙ is within 40 ms:

|ρₖ−ρᵢ|<40ms×c.

Therefore, as described above, once frame synchronization is established for one satellite, the search space for frame synchronization for another satellite can be limited to 40 ms. And once rough user position and rough time are derived, then together with satellite ephemeris data, the range uncertainty can be reduced further. Once the range uncertainty is below 10 ms (i.e., 10 ms×c), then once frame synchronization is achieved for one satellite, one can derive tot for any satellite without decoding the TOW (“time of week”) signal from that satellite.

The discussion so far assumes that all n satellites are from the same GNSS system—e.g., GPS or GLONASS or Beidou/COMPASS or Galileo. However, in accordance with implementations of the subject matter of this disclosure, satellites from different GNSS systems can be used by converting the time bases. For example, the time component of a signal from any satellite, regarding of which GNSS system that satellite belongs to, can be converted to the time base of a particular one of the GNSS systems. Alternatively, the time component of a signal from any satellite, regardless of which GNSS system that satellite belongs to, can be converted to a single reference time base. One such reference time base might be Coordinated Universal Time, also known as UTC or Greenwich Mean Time.

For the four GNSS systems mentioned above—GPS, GLONASS, Beidou/COMPASS and Galileo—the difference between the respective time base of each system and UTC is known. Specifically, UTC is adjusted periodically by “leap seconds” to account for changes in the rate of rotation of the earth. GLONASS time is synchronized to three hours ahead of UTC (i.e., to Moscow time), and is updated with leap seconds when they are added to UTC, so GLONASS time is fixed at UTC+3 hours. GPS time started at UTC 00h:00m:00s on Jan. 6, 1980, Beidou/COMPASS time started at UTC 00h:00m:00s on Jan. 1, 2006, and Galileo time started at UTC 00h:00m:00s on Aug. 22, 1999, but neither GPS time nor Beidou/COMPASS time nor Galileo time is updated for leap seconds. However, the offset, or number of leap seconds, between UTC and any of GPS time, Beidou/COMPASS time and Galileo time is known.

The relationship between UTC and the time for any GNSS can be expressed as follows:

t_{GNSS}=t_{UTC}+ΔT_{GNSS}_{_}_{UTC}+Δt_{GNSS}_{_}_{UTC}

where: t_{GNSS} is GNSS time;
t_{UTC} is UTC time;
ΔT_{GNSS}_{_}_{UTC} is the integer part of the difference between GNSS time and UTC time expressed in seconds; and
Δt_{GNSS}_{_}_{UTC} is the fractional part of the difference between GNSS time and UTC time expressed in seconds.

For GPS, ΔT_{GNSS}_{_}_{UTC} is the accumulated leap seconds since UTC 00h:00m:00s on Jan. 6, 1980. For Beidou/COMPASS, ΔT_{GNSS}_{_}_{UTC} is the accumulated leap seconds since UTC 00h:00m:00s on Jan. 1, 2006. For Galileo, ΔT_{GNSS}_{_}_{UTC} is the accumulated leap seconds since UTC 00h:00m:00s on Aug. 22, 1999. For GLONASS, ΔT_{GNSS}_{_}_{UTC} is fixed to 3 hours.

However, the foregoing system time difference information is not sufficient to allow the signal from a satellite belonging to any GNSS system to be used by a GNSS receiver, because there also is radio delay caused by the receiver circuitry, and that radio delay may be different for signals from satellites from different GNSS systems. And because radio delay may be semiconductor process-dependent, it may be different for different individual receivers.

Therefore, in accordance with implementations of the subject matter of this disclosure, in addition having a time correction applied based on the foregoing system time difference information, the time signal from any GNSS satellite is further corrected according to a radio delay correction which is a function of the receiver radio circuitry. The radio delay may be determined by testing at the time of manufacture or assembly of the receiver and stored in a suitable memory in the receiver. As noted above, the correction may be different on the same receiver for signals from different satellite systems, so multiple radio delay corrections may be stored.

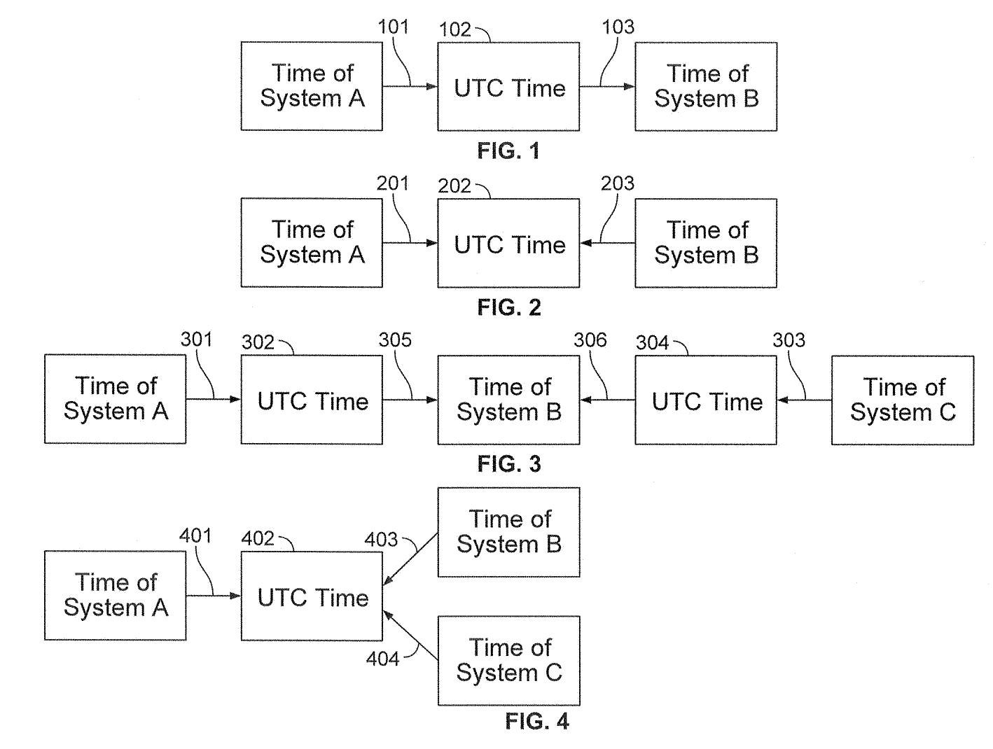

Thus, when a first satellite signal, from a satellite belonging to a first satellite system, is received by a GNSS receiver according to implementations of the subject matter of this disclosure, and then a second satellite signal, from a satellite belonging to a second satellite system, is received by that GNSS receiver, the time base of the second satellite signal may be converted to the time base of the first satellite signal as shown in FIG. 1. In FIG. 1, System A is the second satellite system and System B is the first satellite system. The known system time difference between UTC and the time base of System A, along with the radio delay between UTC and System A stored in the receiver, may be used at 101 to convert the System A time to UTC time 102. Then the known system time difference between UTC and the time base of System B, along with the radio delay between UTC and System B stored in the receiver, may be used at 103 to convert the UTC time to System B time. Calculations then continue using the time base of System B.

Alternatively, as shown in FIG. 2, the known system time difference between UTC and the time base of System A, along with the radio delay between UTC and System A stored in the receiver, may be used at 201 to convert the System A time to UTC time 202. Then the known system time difference between UTC and the time base of System B, along with the radio delay between UTC and System B stored in the receiver, may be used at 203 to also convert System B time to UTC time. Calculations then continue using UTC as the time base.

There may be more than two GNSS systems involved in any set of satellite signals. Theoretically, all four of the aforementioned GNSS systems may be involved. However, the time base conversion principles are the same as in the case of two systems. As an example, FIG. 3 shows an example where satellite signals from three GNSS systems, designated System A, System B and System C, are received. The known system time difference between UTC and the time base of System A, along with the radio delay between UTC and System A stored in the receiver, may be used at 301 to convert the System A time to UTC time at 302. Similarly, the known system time difference between UTC and the time base of System C, along with the radio delay between UTC and System C stored in the receiver, may be used at 303 to convert the System C time to UTC time at 304. Then the known system time difference between UTC and the time base of System B, along with the radio delay between UTC and System B stored in the receiver, may be used at 305 and 306 to convert the UTC times at 302 and 304 to System B time. Calculations then continue using the time base of System B.

Alternatively, as shown in FIG. 4, the known system time difference between UTC and the time base of System A, along with the radio delay between UTC and System A stored in the receiver, may be used at 401 to convert the System A time to UTC time at 402. Then the known system time difference between UTC and the time base of System B, along with the radio delay between UTC and System B stored in the receiver, may be used at 403 to also convert System B time to UTC time at 402. Finally, the known system time difference between UTC and the time base of System C, along with the radio delay between UTC and System C stored in the receiver, may be used at 404 to also convert System C time to UTC time at 402. Calculations then continue using UTC as the time base.

It should be apparent that the time bases of even greater number—i.e., four or more—of GNSS systems can be converted to a common time base in same manner, whether the common time base is the time base of one of the GNSS systems, or a separate time base such as UTC.

Although there is some uncertainty in the time base conversion, converted time can be used to determine a satellite position from the position data (i.e., ephemeris data and almanac data) broadcast by that satellite. Moreover, satellites from different systems with different time bases can be used to determine receiver position without needing to derive a separate receiver clock bias for each time base.

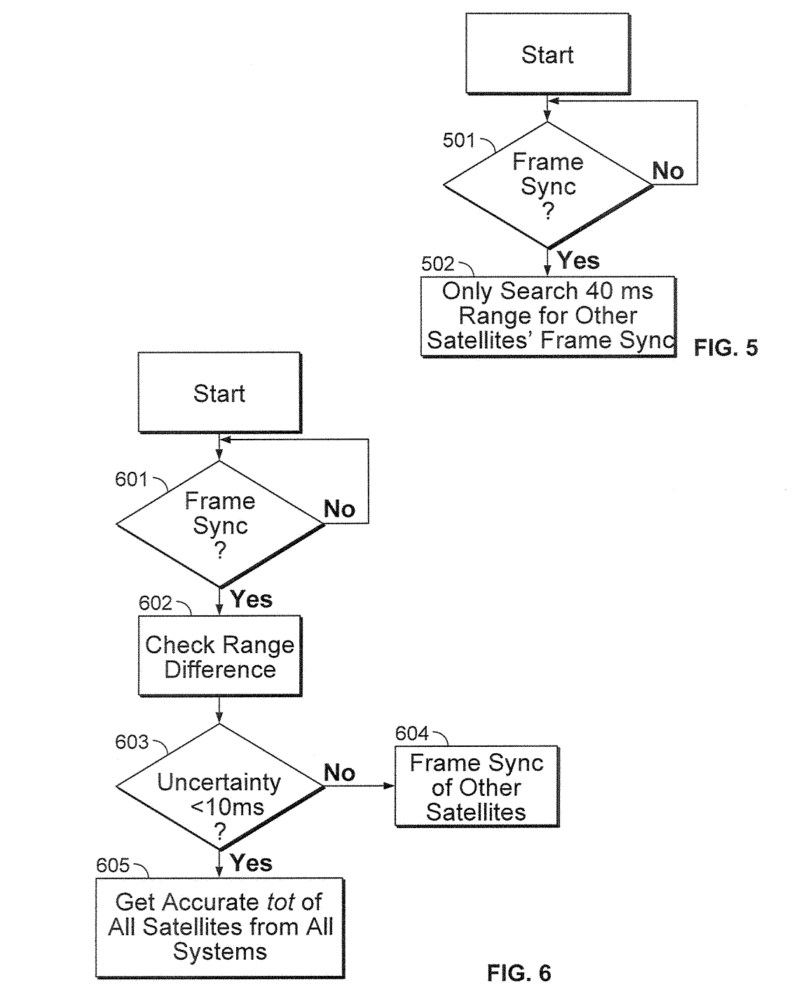

As described above, and as shown in FIG. 5, acquisition of the first satellite starts at 501 where a received signal is observed until frame synchronization is achieved. Once frame synchronization has been achieved, then at 502, a range of 40 ms is searched for frame synchronization for other satellites.

Once a common time base has been established the relationships between the pseudoranges of different satellites (i.e., the pseudorange difference equations set forth above) apply even between satellites from different GNSS systems. Thus, accurate times of transmission tot can be determined without, as noted above, knowing the time of receipt tor accurately.

As also described above, if uncertainty in satellite positions can be reduced to under 10 ms, further advantages may be realized as shown in FIG. 6. Acquisition of a first satellite starts at 601 where a received signal is observed until frame synchronization is achieved. Once frame synchronization is achieved, then at 602 the uncertainty in the range difference is determined. At 603, if the determined uncertainty in the range difference is not less than 10 ms, then at 604, frame synchronization for other satellites is sought. However, if at 603 the determined uncertainty in the range difference is less than 10 ms, then at 605 tot for all satellites, from all systems, can be determined without decoding TOW from each satellite.

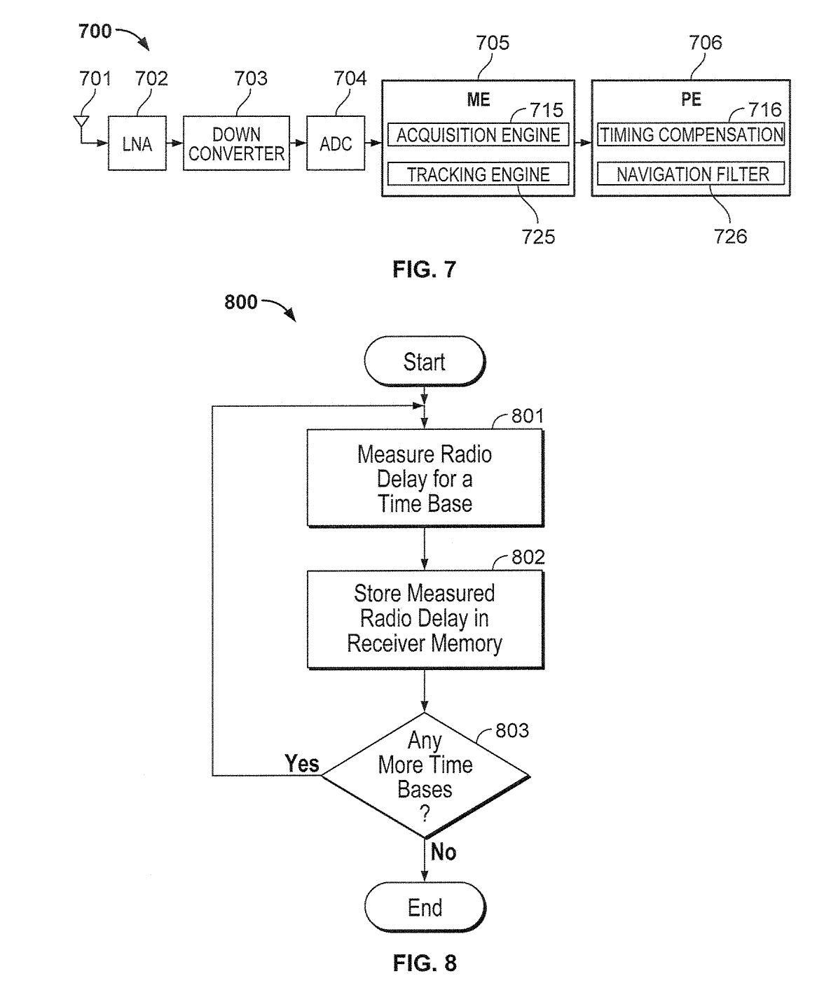

A GNSS receiver 700 embodying the subject matter of this disclosure is diagrammed in FIG. 7. Signals are received at antenna 701 and processed through low-noise amplifier (LNA) 702 to amplify the satellite signal, which may be weak, without significantly increasing the signal-to-noise ratio of the satellite signal. The amplified signal is then downconverted in downconverter 703 to a lower band, and then converted from analog to digital by analog-to-digital converter (ADC) 704 for processing. For example, sampling and quantization may occur in an intermediate-frequency (“IF”) band.

The digitized output of ADC 704 is then processed in the acquisition engine 715 and tracking engine 725 of measurement engine 705 and passed to positioning engine 706. Timing compensation block 716 performs the time base conversions discussed above, and includes the memory (not shown separately) discussed above that stores the radio delay corrections for the different time bases. Navigation filter 726 then determines position, and receiver clock bias, as is known, based on the converted time signals.

A method 800 for configuring a satellite navigation system receiver in accordance with an implementation of the subject matter of this disclosure is diagrammed in FIG. 8. At 801, radio delay of the satellite navigation system receiver is measured for a particular time base (i.e., for a particular satellite system, because the hardware design differs for different satellite systems, resulting in different signal path lengths that result in different radio delays). At 802, the measured radio delay for that time base is stored in memory in the receiver.

At 803, it is determined whether there are any additional time bases for which radio delay needs to be measured. If not, method 800 ends. Otherwise, flow returns to 801 to measure radio delay for the next time base, and method 800 continues from there.

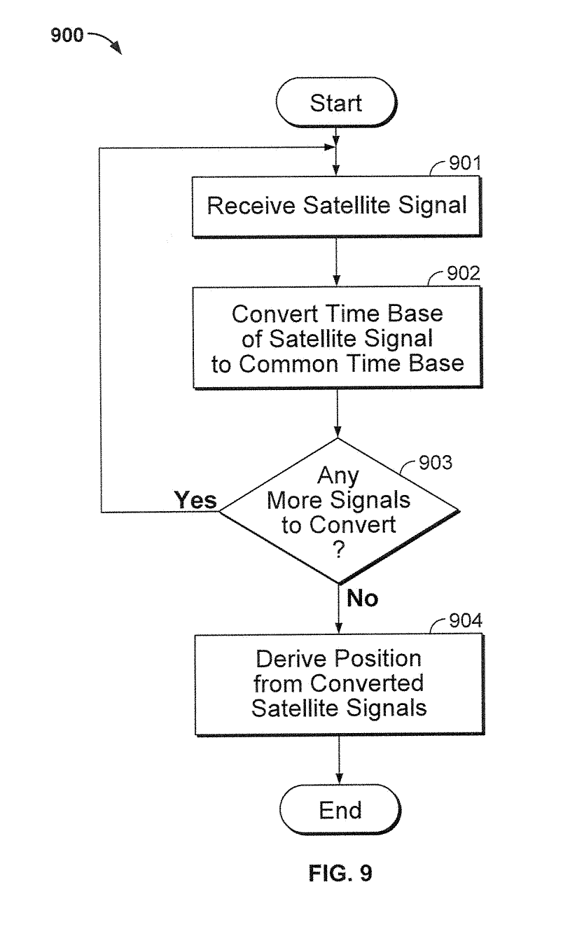

A method 900 for deriving position from signals from satellites belonging to different satellite navigation systems, in accordance with an implementation of the subject matter of this disclosure, is diagrammed in FIG. 9. At 901, a satellite signal is received. At 902, the satellite signal is converted to a common time base. As noted above, the common time base may be the time base of one of the satellite navigation systems, or it may be a completely separate time base such as UTC.

At 903, it is determined whether there are any other signals whose time base needs to be converted (i.e., if signals are being received from any satellites whose time base is not the common time base). If not, then at 904 position is determined from the satellite signals already received and converted, and method 900 ends. But if at 903 it is determined that there is another signal whose time base needs conversion, then flow returns to 901 to receive that signal and method 900 continues from there.

Further aspects of the present invention relate to one or more of the following clauses:

Clause 1: A method of determining a navigational position from satellite navigation signals, the method comprising:

receiving at a satellite navigation receiver a plurality of satellite navigation signals, each respective satellite navigation signal having been transmitted by a respective satellite in a plurality of satellites, wherein at least a first satellite in the plurality of satellites belongs to a first satellite navigation system and at least a second satellite in the plurality of satellites belongs to a second satellite navigation system, and wherein each respective satellite navigation signal transmitted by the respective satellite includes time data based on a time base of a respective satellite navigation system to which the respective satellite belongs;

converting the time data in at least one respective satellite signal from the time base of the respective satellite navigation system to which the respective satellite belongs to make each satellite navigation signal of the plurality of satellite navigation signals usable with each other satellite navigation signal of the plurality of satellite navigation signals; and

deriving the navigational position from the plurality of satellite navigation signals following the converting of the time data in the at least one respective satellite signal.

Clause 2: The method of clause 1 wherein the converting comprises:

applying a known relationship between at least a time base of the first satellite navigation system and a time base of the second satellite navigation system; and

applying a measured hardware correction at the satellite navigation receiver for at least one of the time base of the first satellite navigation system and the time base of the second satellite navigation system.

Clause 3: The method of clause 2 wherein the converting results in conversion of the time base of the first satellite navigation system and the time base of the second satellite navigation system to a common time base.

Clause 4: The method of clause 3 wherein the common time base is one of the time base of the first satellite navigation system and the time base of the second satellite navigation system.

Clause 5: The method of clause 3 wherein the common time base is a time base other than the time base of the first satellite navigation system and the time base of the second satellite navigation system.

Clause 6: The method of clause 5 wherein the common time base is Coordinated Universal Time.

Clause 7: The method of clause 3 wherein the deriving the navigational position from the plurality of satellite navigation signals comprises deriving the navigational position from the plurality of satellite navigation signals that have been converted to the common time base.

Clause 8: The method of clause 2 wherein:

at least a third satellite in the plurality of satellites belongs to a third satellite navigation system, there being a time base of the third satellite navigation system;

the applying the known relationship comprises applying known relationships among the time base of the first satellite navigation system, the time base of the second satellite navigation system and the time base of the third satellite navigation system; and

the applying the measured hardware correction at the satellite navigation receiver comprises applying a respective measured hardware correction for each of the time base of the first satellite navigation system, the time base of the second satellite navigation system and the time base of the third satellite navigation system.

Clause 9: The method of clause 8 wherein the converting results in conversion of the time base of the first satellite navigation system, the time base of the second satellite navigation system, and the time base of the third satellite navigation system, to a common time base.

Clause 10: The method of clause 9 wherein the common time base is one of the time base of the first satellite navigation system, the time base of the second satellite navigation system and the time base of the third satellite navigation system.

Clause 11: The method of clause 9 wherein the common time base is a time base other than the time base of the first satellite navigation system, the time base of the second satellite navigation system and the time base of the third satellite navigation system.

Clause 12: The method of clause 11 wherein the common time base is Coordinated Universal Time.

Clause 13: The method of clause 9 wherein the deriving the navigational position from the plurality of satellite navigation signals comprises deriving the navigational position from the plurality of satellite navigation signals that have been converted to the common time base.

Clause 14: A method of configuring a satellite navigation system receiver to operate with satellites from more than one satellite navigation system, the method comprising:

measuring a respective clock delay of the satellite navigation system receiver for each one of the more than one satellite system; and

storing the respective measured clock delays in a respective memory accessible to a positioning engine in the satellite navigation system receiver.

Clause 15: A satellite navigation system receiver comprising:

a receiver configured to receive a plurality of satellite navigation signals, each respective satellite navigation signal having been transmitted by a respective satellite in a plurality of satellites, wherein at least a first satellite in the plurality of satellites belongs to a first satellite navigation system and at least a second satellite in the plurality of satellites belongs to a second satellite navigation system, and wherein each respective satellite navigation signal transmitted by the respective satellite includes time data based on a time base of one a respective satellite navigation system to which the respective satellite belongs;

a positioning engine including timing compensation circuitry configured to convert the time data in at least one respective satellite signal from the time base of the respective satellite navigation system to which the respective satellite belongs to make each satellite navigation signal of the plurality of satellite navigation signals usable with each other satellite navigation signal of the plurality of satellite navigation signals; and

a navigation filter in the positioning engine, the navigation filter being configured to derive the navigational position from the plurality of satellite navigation signals following converting by the timing compensation circuitry of the time data in the at least one respective satellite signal.

Clause 16: The satellite navigation system receiver of clause 15 wherein:

the timing compensation circuitry is configured to apply a known relationship between at least a time base of the first satellite navigation system and a time base of the second satellite navigation system; and

the timing compensation circuitry is configured to apply a measured hardware correction at the satellite navigation receiver for at least one of the time base of the first satellite navigation system and the time base of the second satellite navigation system.

Clause 17. The satellite navigation system receiver of clause 16 wherein the timing compensation circuitry converts the time base of the first satellite navigation system and the time base of the second satellite navigation system to a common time base.

Clause 18: The satellite navigation system receiver of clause 17 wherein the common time base is one of the time base of the first satellite navigation system and the time base of the second satellite navigation system.

Clause 19: The satellite navigation system receiver of clause 17 wherein the common time base is a time base other than the time base of the first satellite navigation system and the time base of the second satellite navigation system.

Clause 20: The satellite navigation system receiver of clause 19 wherein the common time base is Coordinated Universal Time.

Thus it is seen that a method, and apparatus, for using satellites from different GNSS systems in a single GNSS receiver has been provided. Implementations of the subject matter of this disclosure may determine user position more quickly than a GNSS receiver that uses satellites from only one GNSS system at a time, because a sufficient number of satellite signals may be acquired more quickly if signals from satellites from multiple systems can be used.

As used herein and in the claims which follow, the construction “one of A and B” shall mean “A or B.”

It will be understood that the foregoing is only illustrative of the principles of the invention, and that the invention can be practiced by other than the described embodiments, which are presented for purposes of illustration and not of limitation, and the present invention is limited only by the claims which follow.

What is claimed is:

1. A method of determining a navigational position from satellite navigation signals, the method comprising:
receiving at a satellite navigation receiver a plurality of satellite navigation signals, each respective satellite navigation signal having been transmitted by a respective satellite in a plurality of satellites, wherein at least a first satellite in the plurality of satellites belongs to a first satellite navigation system and at least a second satellite in the plurality of satellites belongs to a second satellite navigation system, and wherein each respective satellite navigation signal transmitted by the respective satellite includes time data based on a time base of a respective satellite navigation system to which the respective satellite belongs;
converting the time data in at least one respective satellite signal from the time base of the respective satellite navigation system to which the respective satellite belongs to make each satellite navigation signal of the plurality of satellite navigation signals usable with each other satellite navigation signal of the plurality of satellite navigation signals; and
deriving the navigational position from the plurality of satellite navigation signals following the converting of the time data in the at least one respective satellite signal.

2. The method of claim 1 wherein the converting comprises:
applying a known relationship between at least a time base of the first satellite navigation system and a time base of the second satellite navigation system; and
applying a measured hardware correction at the satellite navigation receiver for at least one of the time base of the first satellite navigation system and the time base of the second satellite navigation system.

3. The method of claim 2 wherein the converting results in conversion of the time base of the first satellite navigation system and the time base of the second satellite navigation system to a common time base.

4. The method of claim 3 wherein the common time base is one of the time base of the first satellite navigation system and the time base of the second satellite navigation system.

5. The method of claim 3 wherein the common time base is a time base other than the time base of the first satellite navigation system and the time base of the second satellite navigation system.

6. The method of claim 5 wherein the common time base is Coordinated Universal Time.

7. The method of claim 3 wherein the deriving the navigational position from the plurality of satellite navigation signals comprises deriving the navigational position from the plurality of satellite navigation signals that have been converted to the common time base.

8. The method of claim 2 wherein:
at least a third satellite in the plurality of satellites belongs to a third satellite navigation system, there being a time base of the third satellite navigation system;
the applying the known relationship comprises applying known relationships among the time base of the first satellite navigation system, the time base of the second satellite navigation system and the time base of third satellite navigation system; and
the applying the measured hardware correction at the satellite navigation receiver comprises applying a respective measured hardware correction for each of the time base of each of the first satellite navigation system, the time base of the second satellite navigation system and the time base of the third satellite navigation system.

9. The method of claim 8 wherein the converting results in conversion of the time base of the first satellite navigation system, the time base of the second satellite navigation system, and time base of the third satellite navigation system, to a common time base.

10. The method of claim 9 wherein the common time base is one of the time base of the first satellite navigation system, the time base of the second satellite navigation system and the time base of the third satellite navigation system.

11. The method of claim 9 wherein the common time base is a time base other than the time base of the first satellite navigation system, the time base of the second satellite navigation system and the time base of the third satellite navigation system.

12. The method of claim 11 wherein the common time base is Coordinated Universal Time.

13. The method of claim 9 wherein the deriving the navigational position from the plurality of satellite navigation signals comprises deriving the navigational position from the plurality of satellite navigation signals that have been converted to the common time base.

14. A method of configuring a satellite navigation system receiver to operate with satellites from more than one satellite navigation system, the method comprising:
measuring a respective clock delay of the satellite navigation system receiver for each one of the more than one satellite system; and
storing the respective measured clock delays in a respective memory accessible to a positioning engine in the satellite navigation system receiver.

15. A satellite navigation system receiver comprising:
a receiver configured to receive a plurality of satellite navigation signals, each respective satellite navigation signal having been transmitted by a respective satellite in a plurality of satellites, wherein at least a first satellite in the plurality of satellites belongs to a first satellite navigation system and at least a second satellite in the plurality of satellites belongs to a second satellite navigation system, and wherein each respective satellite navigation signal transmitted by the respective satellite includes time data based on a time base of a respective satellite navigation system to which the respective satellite belongs;
a positioning engine including timing compensation circuitry configured to convert the time data in at least one respective satellite signal from the time base of the respective satellite navigation system to which the respective satellite belongs to make each satellite navigation signal of the plurality of satellite navigation signals usable with each other satellite navigation signal of the plurality of satellite navigation signals; and
a navigation filter in the positioning engine, the navigation filter being configured to derive the navigational position from the plurality of satellite navigation signals following converting by the timing compensation circuitry of the time data in the at least one respective satellite signal.

16. The satellite navigation system receiver of claim 15 wherein:
the timing compensation circuitry is configured to apply a known relationship between at least a time base of the first satellite navigation system and a time base of the second satellite navigation system; and
the timing compensation circuitry is configured to apply a measured hardware correction at the satellite navigation receiver for at least one of the time base of the first satellite navigation system and the time base of the second satellite navigation system.

17. The satellite navigation system receiver of claim 16 wherein the timing compensation circuitry converts the time base of the first satellite navigation system and the time base of the second satellite navigation system to a common time base.

18. The satellite navigation system receiver of claim 17 wherein the common time base is one of the time base of the first satellite navigation system and the time base of the second satellite navigation system.

19. The satellite navigation system receiver of claim 17 wherein the common time base is a time base other than the time base of the first satellite navigation system and the time base of the second satellite navigation system.

20. The satellite navigation system receiver of claim 19 wherein the common time base is Coordinated Universal Time.
